(19) United States
(12) Patent Application Publication
(10) Pub. No.: US 2009/0202891 A1
(43) Pub. Date: Aug. 13, 2009

(54) Inertially activated battery

(76) Inventor: Mel Morganstein, Silver Springs, MD (US)

Correspondence Address: U S ARMY RESEARCH LABORATORY;ATTN AMSRL CS CC IP, 2800 POWDER MILL RD, ADELPHI, MD, 207831197, US

(21) Appl. No.: 10/985,066

(22) Filed: Nov. 5, 2004

(51) Int. Cl. H01M 2/38

(52) U.S. Cl. 429/80

(57) ABSTRACT

An inertially activated electrochemical cell has a first and a second electrode and an electrolyte. The electrolyte, or at least an active component thereof, is enclosed in an encapsulant which can be disrupted when a compressive force is applied thereto. When the electrolyte material is encapsulated, the cell is inactive and has a long storage life. When the cell is exposed to a predetermined level of acceleration or deceleration, the encapsulant is subjected to a compressive force causing it to be thereby disrupted freeing the electrolyte material and rendering the cell active.

### GOVERNMENT INTEREST

The invention described herein may be manufactured, used, and licensed by or for the United States Government.

### FIELD OF THE INVENTION

This invention relates generally to batteries. More specifically, the invention relates to a battery cell which has a very long shelf storage life and which can be activated to produce electrical current upon exposure to an inertial force.

### BACKGROUND OF THE INVENTION

Projectiles for ordnance systems such as artillery shells, rocket propelled munitions, mortar shells and the like are becoming increasingly sophisticated. Modern projectiles comprise a heavy metal case which is filled with a high explosive, and they very often include electrical circuits associated with devices such as proximity fuzes, time delay fuzes, contact fuzes, data reporting systems, arming systems and the like. These circuits require that a source of electrical power be associated with the fuze or other element of the assembled projectile. However, particular needs and criteria associated with such ordnance complicate the problem of including a source of electrical power therein. Projectiles are generally expected to remain effective and reliable for storage periods of twenty years or more. Furthermore, projectiles should not be adversely affected by temperature extremes, adverse atmospheric conditions, and mechanical shocks associated with normal shipping and handling. Also, such projectiles should not require any extensive activation or preparation procedures prior to use. Frequently, projectiles are manufactured as hermetically sealed units, which further complicates problems of providing long term reliable electrical power thereto. While conventional battery systems, such as lithium batteries and the like, can provide relatively long shelf life, typical battery systems cannot provide the simple, highly reliable long term power sources required for ordnance systems.

In response to the shortcomings of conventional active electrochemical batteries, some specific battery systems have been developed for use in projectiles. These are termed “reserve” batteries. They remain electrochemically inert until just prior to use, thus preserving the active ingredients until they are needed. One prior art approach involves the use of what are termed “liquid reserve” battery systems. In battery systems of this type, an electrolyte material is stored separate from the remainder of the battery in an ampule or the like. Such systems are fairly complicated since the ampule stores the electrolyte material separate from the remainder of the battery, and in use, the liquid must be released from the ampule and conveyed to the battery electrodes. This is generally accomplished by the use of linear acceleration or “setback” to activate a mechanism that opens the ampule, and centrifugal force generated by a spinning projectile. However, various projectiles such as rocket propelled projectiles, mortar shells and the like do not experience significant spin when fired. In other instances, wicking devices and the like are used to convey the electrolyte; however, such conduction can be relatively slow, and can be impeded by high g-forces generated when the projectile is fired. Also, the entire electrolyte storage and distribution system takes up precious volume and may be quite complex, adding significantly to the cost of and complicating the reliability of the reserve battery.

Another prior art approach to providing reserve power to projectiles involves the use of what are termed “thermal batteries.” These devices comprise batteries having a solid electrolyte material, such as a salt, disposed between the battery electrodes. When the projectiles are in storage, the electrolyte is at room temperature and is solid; hence, the battery is inactive. When the projectile is fired, the electrolyte is melted, typically by heating it with a dedicated pyrotechnic charge. The molten electrolyte then allows for ionic conductivity between the battery electrodes. Devices of this type can provide long term storage stable power; however, they are fairly complicated devices since they require ignition of a pyrotechnic charge to melt the electrolyte. In addition, these devices experience a lag time before full power is generated. In addition, a significant portion of the volume of the battery is dedicated to thermal “sinks” and insulating materials required to maintain the electrolyte in a molten, and thus active, state.

As will be seen from the above, there is a need for a power source which can reliably deliver electrical power after being stored for periods of twenty years or more. The device should also be rugged, simple to actuate, and be capable of delivering electrical power instantaneously upon activation. As will be explained hereinbelow, the present invention is directed to a power source meeting these criteria. These and other advantages of the invention will be apparent from the drawings, discussion and description which follow.

### BRIEF DESCRIPTION OF THE INVENTION

There is disclosed herein an inertially activated electrochemical cell. The cell includes a first electrode and a second electrode as well as an electrolyte which establishes ionic communication between the electrodes. At least one component of the electrolyte is disposed within an encapsulant so that when that at least one component is so enclosed, the electrolyte is not capable of establishing ionic communication between the electrodes. The encapsulant is capable of being disrupted by the application of a predetermined level of a compressive force thereto so as to cause the release of the at least one electrolyte component so that the electrolyte establishes ionic communication between the electrodes. The cell includes an inertially activated compressive force generator disposed in mechanical communication with the encapsulant body. The force generator is operable, when accelerated, to apply a compressive force to the encapsulant body.

In specific embodiments, the encapsulant and electrolyte component are disposed between the electrodes, and the cell may further include an absorbent body disposed between the electrodes, which absorbent body is capable of retaining the electrolyte therein. The encapsulant body may comprise a plurality of microcapsules such as microcapsules of a polymeric material or of an inorganic material such as a glass or ceramic material. The microcapsules may, in some embodiments, be disposed within the absorbent body. The inertially activated compressive force generator may comprise a portion of the cell such as one or more of the electrodes, a cell housing, or the like, or it may comprise a separate inertial mass in mechanical communication with the encapsulant. In some instances, the walls of the encapsulant itself may comprise the inertial force generator, in which instance, the encapsulant is capable of being disrupted by exposure to an accelerating or decelerating force. Also disclosed herein is a projectile which includes the inertially activated electrochemical cell of the present invention.

### BRIEF DESCRIPTION OF THE DRAWINGS

FIG. 1 is a cross-sectional view of one embodiment of inertially activated battery structured in accord with the principles of the present invention;

FIG. 2 is a cross-sectional view of a portion of an inertially activated electrochemical cell of the present invention including an absorbent body;

FIG. 3 is a cross-sectional view of a portion of an inertially activated electrochemical cell of the present invention including an absorbent body having an encapsulated electrolyte material dispersed therethrough;

FIG. 4A is a cross-sectional view of another embodiment of an inertially activated electrochemical cell of the present invention shown in its unactivated state; and

FIG. 4B is a cross-sectional view of the cell of FIG. 4A shown in its activated state.

### DETAILED DESCRIPTION OF THE INVENTION

The present invention is directed to an electrochemical cell, such as a cell of a power generating battery, which cell can be converted from an inactive, storage-stable state, to an activated, power generating state by application of an inertial force thereto. As is to be understood, within the context of this disclosure, an inertial force is a force, sometimes referred to as a g-force, caused by a change in the speed of travel of a body. Acceleration, typically referred to as “setback” in professions dealing with ordnance design, or deceleration of a body will produce an inertial force on the body.

The cells of the present invention, as is typical of power generating electrochemical cells, include a first and a second electrode, as well as an electrolyte which establishes ionic communication between the electrodes. The cell will typically include terminals and/or leads for withdrawing power from the cell, and may also include auxiliary items such as electrode spacers, housings and the like. As is known in the art, a typical power generating system will usually comprise a battery comprised of a number of individual cells electrically interconnected in a series and/or parallel relationship, selected to provide a desired current and voltage output. Within the context of this disclosure, the terms “cell” and “battery” will be used interchangeably to refer to electrical power generating devices.

It is a significant feature of the present invention that the electrochemical cell includes an encapsulant which retains the electrolyte, or at least one active component thereof, so that there is no ionic communication between the electrodes when the electrolyte or component is so retained. In such instance, the cell is inert and storage stable. The encapsulant is capable of being disrupted upon the application of a compressive force thereto so as to release the electrolyte material thereby establishing ionic communication between the electrodes and thus activating the cell.

Typical battery electrolytes include a solvent component such as water, another inorganic solvent, or an organic solvent, as well as a current-carrying ionic material such as a salt or the like. In some instances, the entirety of the electrolyte may be retained within the encapsulant while in other instances, a component of the electrolyte such as the solvent or the ionic material may be retained within the encapsulant. As will be explained in detail hereinbelow, the encapsulant may comprise any body of material which is compatible with the electrolyte material and which is capable of being disrupted upon the application of a compressive force thereto. Such encapsulant materials can include organic polymers as well as inorganic materials such as glass, ceramics, and the like.

In some particular embodiments of the present invention, the encapsulant material comprises a plurality of microcapsules. As is known in the art, there is an extensive body of technology which has developed relating to microencapsulation of various materials including organic materials, aqueous materials, and particulates. For example, materials and methods for microencapsulation of a variety of substances are disclosed in U.S. Pat. Nos. 4,379,071; 6,103,662; 5,464,803; and 5,401,443, as well as in patents referred to therein, all of which are incorporated herein by reference. There is also an extensive body of technical literature relating to microencapsulation techniques and materials, and by reference thereto one of skill in the art could readily select appropriate materials and methods to encapsulate battery electrolyte materials for the practice of the present invention.

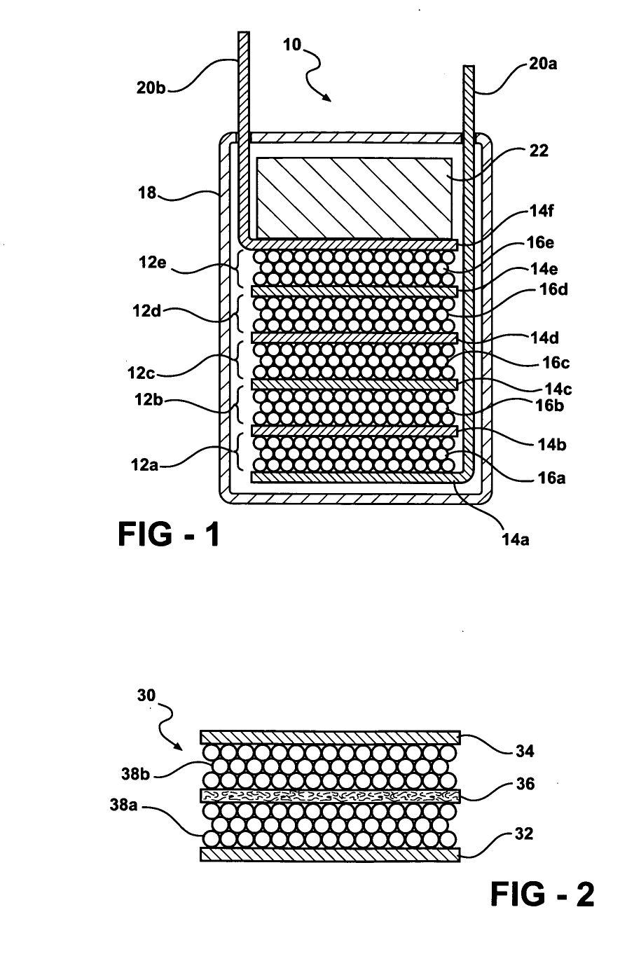

Details of the present invention will be explained with reference to specific illustrated embodiments, it being understood that various other embodiments and applications will be apparent to one of skill in the art and are within the scope of this invention. Referring now to FIG. 1, there is shown one embodiment of an inertially activated electrochemical battery structured in accord with the principles of the present invention. The battery 10 of FIG. 1 is comprised of five individual cells 12a-12e which are disposed in an electrical series relationship. It is to be understood that other embodiments may include a larger or smaller number of cells. The battery 10 includes six electrodes 14a-14f which are separated from one another by bodies of microcapsules 16a-16e each of which contain an electrolyte material in accord with the present invention. Thus, for example, cell 12a is comprised of electrodes 14a and 14b together with the body of encapsulated electrolyte material 16a disposed therebetween.

As explained hereinabove, the body of encapsulated electrolyte material 16 comprises a plurality of microcapsules, which in one embodiment are in the size range of 0.001-10 millimeters, which microcapsules enclose at least some portion of the electrolyte therein. As shown in FIG. 1, the microcapsules 16 are all intact, and hence the battery is inert since there is no ionic communication between the electrodes. When the battery is in this mode, it has long term storage stability.

As will be further noted in FIG. 1, the battery 10 is disposed within a housing 18, which may be fabricated from a polymeric material or from an inorganic material such as a metal, a ceramic, or glass. In some instances, the housing may be formed from a composite material. In general, the housing should be capable of withstanding the very high setback forces, often in excess of 25,000-35,000 g, during gun launch. As will be further noted, a first electrical terminal 20a is in electrical communication with the bottom electrode 14a of the battery, and a second terminal 20b is in electrical communication with the top electrode 14f of the battery. These terminals 20 serve to convey power from the battery.

The FIG. 1 embodiment also includes an inertial mass 22 which is in mechanical communication with the electrodes 14 and the body of encapsulated electrolyte material 16. When the battery 10 of FIG. 1 is subjected to an appropriately directed inertial force, as for example when a projectile is launched, the inertial mass 22 will communicate a compressive force to the body of encapsulated electrolyte material 16 thereby rupturing the capsules, freeing the electrolyte material, and activating the battery so as to generate electrical current. In order to accommodate motion of the battery components occasioned by the compression, the leads associated with the terminals 20 may be made extensible, as for example by including a number of bends or coils therein. Alternatively, the housing 18 may be configured to allow for compressive motion.

While the FIG. 1 embodiment shows the use of an inertial mass 22 to compress the capsules, in particular embodiments, this mass may not be necessary. For example, the electrodes themselves may have sufficient inertial mass to cause compression and rupturing of the capsules, in which case the electrodes will function as an inertial force generator. In other instances, a portion of the battery housing may accomplish the same function, while in yet other embodiments, a portion of the encapsulant material itself may have sufficient inertial mass to cause capsule rupturing upon exposure to large changes in speed as for example when a projectile is launched. Therefore, it is to be understood that the inertially activated compressive force generator element of this interpretation is to be interpreted broadly. Also, while the electrolyte material is shown in these examples as being disposed within microcapsules, the electrolyte material may, in other embodiments of the invention, be disposed in one or more capsules of a larger size. For example, the electrolyte material may be in one or several relatively large capsules disposed between the two electrodes of a cell.

One advantage of the present invention can be implemented in embodiments in which the encapsulated electrolyte material is maintained in very close proximity to the electrodes of the battery. This provides for rapid and reliable battery activation. As is known in the art, battery electrodes are often maintained in a spaced apart relationship by a body of separator material which can also function to assist in retaining the electrolyte proximate to the electrodes, and in specific embodiments of the present invention, such electrolyte absorbent structures may be included.

Referring now to FIG. 2, there is shown a portion 30 of an electrochemical cell incorporating an electrolyte absorbent body. FIG. 2 depicts a cross-sectional view of a portion of a cell 30 comprised of a first electrode 32 and a second electrode 34. Disposed therebetween is a body of a fibrous material 36 as well as two bodies of encapsulated electrolyte material 38a, 38b. The fibrous material 36 functions as an electrolyte absorbent as well as a separator for the two electrodes 32 and 34. In those instances where only a portion of the electrolyte is disposed within the capsules 38a, 38b, the remainder of the electrolyte may be absorbed within the absorbent body 36. Upon rupture of the bodies of capsules 38a, 38b, the electrolyte material will permeate the fibrous absorbent body 36, which aids in retaining the electrolyte material in proximity to the electrodes 32 and 34, and activation of the cell is thereby achieved.

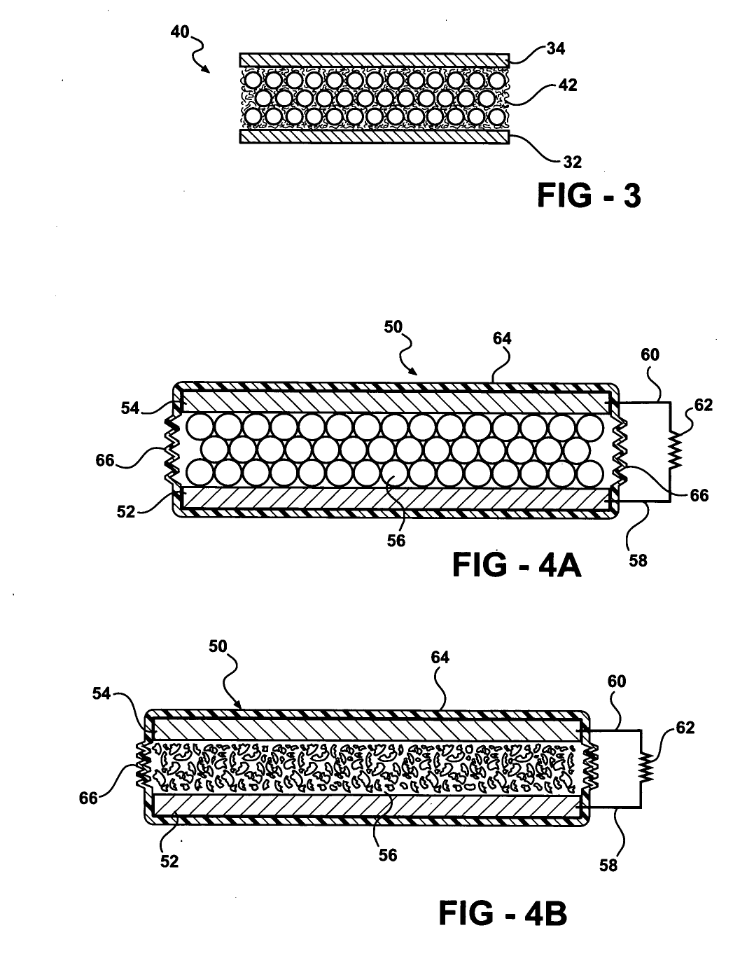

Referring now to FIG. 3, there is shown another embodiment of cell 40. The cell 40 of FIG. 3 includes a first electrode 32 and a second electrode 34 as previously described. This embodiment also includes an absorbent body 42 having a plurality of microcapsules disposed therein. As in the previous embodiments, the microcapsules enclose at least some portions of an electrolyte. As in the previous embodiments, rupture of the microcapsules creates an activated cell.

The present invention may be implemented in yet other embodiments. Referring now to FIG. 4A, there is shown an inertially activated electrochemical battery 50, comprised of a single cell which includes two electrodes 52 and 54 as well as a body of encapsulated electrolyte material 56 disposed therebetween. As illustrated, a first electrical lead 58 is associated with the first electrode 52 and a second electrical lead 60 is associated with the second electrode 54. These leads serve to deliver electrical power to a load 62. The battery of FIG. 4A is disposed within a housing 64, which in this instance is a compressible housing, and toward that end includes a corrugated midsection 66. The compressible housing 64 is fabricated from a deformable material such as a soft metal, a polymeric material or the like. When the battery of FIG. 4A is subject to a compressive force, the housing 64 deforms allowing the microencapsulant 56 to be ruptured thereby releasing the electrolyte material.

Referring now to FIG. 4B, the cell 50 is shown in its compressed, activated form. As will be seen, the housing 64 has deformed about the corrugated region 66 compressing the microcapsules 56 thereby rupturing them and releasing the electrolyte material. As will be understood, the FIG. 4A and FIG. 4B embodiment may also include an absorbent body as detailed above. Also, the battery of FIG. 4A and FIG. 4B may be configured to include a larger number of cells therein. Likewise, the FIG. 4A and FIG. 4B embodiment may include a separate inertial mass to enhance the compression thereof.

The electrochemical cells of the present invention provide power sources which may be stored for very long periods of time in an inactivated state, and which may be activated by inertial forces such as forces of acceleration or deceleration. Furthermore, the cells of the present invention may be made as hermetically sealed units which need not be opened for activation.

While the cells of the present invention have been primarily described with reference to their use in artillery shells, rockets, mortar shells and other such projectiles, the specific advantages of these cells will also make their use advantageous in other systems in which long term power storage is required. For example, the cells of the present invention may be employed in sensor or data storage and reporting devices such as sonobouys, weather sensors, intrusion sensors and the like. In many instances, devices of this type are dropped from aircraft, and deceleration forces experienced thereby upon impact can be utilized to activate the battery. Likewise, the principles of the present invention may be employed to provide a non-integral battery system having very long shelf life. Batteries of this type can be activated by striking them on a hard surface or by tapping them with a hammer or the like.

As will be appreciated from the foregoing, various modifications and variations of the present invention will be apparent to one of skill in the art and may be implemented without undue experiment. The foregoing drawings, discussion and description are illustrative of specific embodiments of the invention, but are not meant to be limitations upon the practice thereof. It is the following claims, including all equivalents, which define the scope of the invention.

1-19. (canceled)

20. A battery for a projectile comprising:
a casing being a substantially hollow vessel and having a top and closed bottom with two apertures located in said top;
two “L” shaped terminals placed into the casing through said top apertures and located opposite one another, the bottom portions of each terminal being parallel to one another and spaced a distance apart;
a plurality of electrodes disposed between said terminals and separated from one another by layers of stacked frangible microcapsules that contain an electrolyte material;
a fibrous separator material disposed between each of said electrodes;
at least one of said terminals being moveably affixed to said casing; and
at least one inertial mass in communication with at least one of said moveably affixed terminals in order to apply a compressive force through physical contact caused by motion against said layers of stacked frangible microcapsules when subjected to a setback force.

21. (canceled)

22. The battery according to claim 1 wherein the inertial mass is affixed to the moveable terminal.

23. The battery according to claim 1 wherein the inertial mass is an integral portion of said terminal.
